(19) United States
(12) Patent Application Publication
(10) Pub. No.: US 2005/0229119 A1
(43) Pub. Date: Oct. 13, 2005

(54) Method for the presentation and selection of document links in small screen electronic devices

(75) Inventor: Marko Torvinen, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/820,432

(22) Filed: Apr. 7, 2004

(51) Int. Cl. G06F 3/00; G06F 17/21

(52) U.S. Cl. 715/864; 715/513; 715/501.1; 715/760; 715/781; 715/788; 715/808; 715/809; 715/816; 715/862

(57) ABSTRACT

A method, an electronic device and a computer program, for document link presentation and selection in an electronic device. In the method a first hypertext page comprising at least one separate link area is opened in an electronic device. At least part of said first hypertext page is displayed in a view window movable in the area of said first hypertext page. A link area nearest to a first point on said view window is determined. A link list comprising links associated with said link area is formed. As a user selects a first link in the link list and a second hypertext page indicated by the first link is opened in the electronic device.

### BACKGROUND OF THE INVENTION

1. Field of the Invention

The invention relates to user interfaces in computing equipment. Particularly, the invention relates to the presentation and selection of document links in small screen electronic devices.

2. Description of the Related Art

User friendliness is an important factor in all computer applications. Especially, it is of particular importance in applications targeted for average users and frequent use. The providing of user interfaces for devices with small screens requires particular consideration. It is important to be able to browse similar content and to use similar applications in devices with small screens as in devices with full-size screens. Currently, the most important type of content is hypertext browsed using Internet browsers.

Recently, browser applications tailored for browsing HTML content in small screen devices have appeared. Examples of such browsers are the DORIS™ by Anygraaf Oy and OPERA™ by Opera Software for SYMBIAN™ operating system devices such as the NOKIA™7650 mobile phone. Such a browser usually operates by loading an entire HTML page and by displaying a fragment of the HTML page in a window sized for the small screen. The window may be relocated on the HTML page so that a desired part of the HTML page may be obtained for viewing. There are two options for moving the window in the area of the HTML page. In the first option the window may be moved only vertically and the HTML page is squeezed to a narrow column fitting the window. In the second option the window may be moved vertically and horizontally, and the HTML page maintains its original width.

The pointer devices from larger screen devices are cumbersome to use in small screen devices. This is due to the fact that greater precision is required when operating a browser in a small screen device. One option is to limit the operation of the pointer device so that a cursor may be moved only between textual hyperlinks. This option has been used in aforementioned OPERA™ and DORIS™ browsers. The disadvantage of this option is that bit-mapped images, that is, hyperlinks bound to picture portions cannot be used. Of course, free-hand pointer device operation may be applied normally within a window currently being presented in the small screen. This unfortunately requires precision, which may be intolerable, for example, while operating the device while walking.

Another option for solving the problem is presented in U.S. patent application Ser. No. 10/197,245 “SYSTEM, APPARATUS, AND METHOD FOR FACILITATING LINK SELECTION ON ELECTRONIC DEVICES”, which was filed on Jul. 17, 2002. In the method disclosed, for facilitating user selection of links presented on a display, there is defined at least one snap area associated with one or more links. The snap area includes a region extending beyond the boundaries of the link. When a cursor operated using a pointer device enters the snap area one or more characteristics of a target link are modified. For example, the target link may be presented using a different color and highlighted. Simultaneously other visual, audio or tactile feedbacks may be provided to the user to indicate the entering of the snap area. Furthermore, the snap area size may be adjusted based on previous user actions pertaining to link selections.

Reference is now made to FIG. 1, which illustrates the method for facilitating user selection of links presented on a display as disclosed in U.S. patent application Ser. No. 10/197,245. In FIG. 1 there is a mobile terminal 100, which is equipped with a keypad 110, programmable function keys 120 and 124, a pointer device 122 and display 130. The contents of display 130 at a given point in time are illustrated as magnified in a box 140. On display 130 there is presented a hypertext page, which comprises a page header 142 and a hyperlink menu comprising links 144-152. On display 130 there is also presented a separate banner 158, which is used to select an advertisement associated with the page. The hypertext page may be, for example, a Wireless Application Protocol (WAP) page defined using Wireless Markup Language (WML) or an HTML page. The page may have been retrieved to mobile terminal 100 from a network, for example, using General Packet Radio System (GPRS).

Using pointer device 122 is controlled a cursor 156. In the area surrounding link 148 there is a snap area 154. Snap area 154 extends beyond the normal boundaries of the text associated with link 148 on display 130. This may be due to the fact that the user has on previous occasions preferred link 148 instead of other links on the page. Pointer device 122 may be, for example, a finger-operated joystick, the guiding of which in the vertical or the horizontal direction results in cursor 156 being moved in the vertical or the horizontal direction, respectively. The pointer device may also be, for example, a mini-trackball or a flat sliding button. The pressing of the joystick inwards produces a pointer device event, which corresponds to the clicking of the link selection button on a standard mouse. In other words, the pressing of the joystick directly inwards when cursor 156 is in a given snap area results in the selection of the hyperlink associated with the snap area.

A disadvantage of a solution such as presented in FIG. 1 is that it requires the gathering of user action history in order to be able to determine, which link selections are more probable for a given user and which links need to have their snap area enlarged. The solution works well on pages that have often been visited in the past, but not so well on unfamiliar pages. The analysis of user action history in order to determine probable future actions is unreliable and may require significant processing in a mobile terminal. Bad guesses on user preferences may become a nuisance rather than an aid. A further disadvantage of a solution of this kind is that it does not consider the cases where a piece of an HTML page is presented in a window sized for the small screen and the window can be relocated on the HTML page so that a desired part of the HTML page may be obtained for viewing.

### SUMMARY OF THE INVENTION

The invention relates to a method for document link presentation and selection in an electronic device. In the method a first hypertext page comprising at least one separate link area is opened in the electronic device; at least part of the first hypertext page is displayed in a view window movable in the area of the first hypertext page; a link area nearest to a first point on the view window is determined; a link list comprising links associated with the link area is formed; a user is allowed to select a first link in the link list; and a second hypertext page indicated by the first link is opened in the electronic device.

The invention relates also to an electronic device for document link presentation and selection. The electronic device comprises: a memory to store at least a browser application; a display to show a view window; a pointer device; a processor coupled to the memory, the display and the pointer device, wherein the processor is arranged to open a first hypertext page comprising at least one separate link area, to display at least part of the first hypertext page in the view window, to move the view window in the area of the first hypertext page in response to operation of the pointer device, to determine a link area nearest to a first point on the view window, to form a link list comprising links associated with the link area, to allow a user to select a first link in the link list, and to open a second hypertext page indicated by the first link.

The invention relates also to a computer program comprising code adapted to perform the following steps when executed on a data-processing system: opening a first hypertext page comprising at least one separate link area in an electronic device; displaying in the display of the electronic device at least part of the first hypertext page in a view window movable in the area of the first hypertext page; determining in the electronic device a link area nearest to a first point on the view window; forming in the electronic device a link list comprising links associated with the link area; selecting a first link in the link list; and opening in the electronic device a second hypertext page indicated by the first link.

In one embodiment of the invention, the link list is activated in response to a user interface event, for example, the pressing of a function key. Thereupon, the link list is presented in a separate window, which allows the user to select one of the links in the link list.

In one embodiment of the invention, a logical order for at least two links in the link list is determined based on a spatial order of the link descriptions on the first hypertext page; at least two keys in the electronic device are assigned for the at least two links based on the logical order; and the selection of the first link is communicated by pressing one of the at least two keys. In one embodiment of the invention, the at least two keys are function keys. The function keys may be arranged, for example, in a row below a display in the electronic device or in a row above a keyboard in the electronic device. The order in which the links in the link list are assigned to the function keys is arranged to correspond to the spatial order in which the link descriptions are presented on the electronic device display. For example, if the link descriptions appear on the display as a vertical item list, the associated links are assigned to the function keys in a corresponding horizontal order.

In another embodiment of the invention, the at least two keys are number keys. The number keys may be located, for example, in a number keypad of the electronic device.

In one embodiment of the invention, the user may select links in the link list without opening the link list in a separate window. In this embodiment, the user is provided with quick keys that are assigned to particular links in the link list. For example, by pressing a given number key, the user may indicate to the electronic device that she wishes to open a link corresponding to that number in the link list. This is achieved so that links in the link list are assigned different numbers. The link numbering may be assigned based on, for example, a spatial order of the link descriptions on the link area. In one embodiment of the invention, on the first press of the number key, the user is presented the link description associated with that number key. Thereupon, the user may select that link by pressing the number key repeatedly or by pressing another key that acknowledges the opening of the link.

In one embodiment of the invention, the first point is a stationary point on the view window and the link area nearest to the stationary point is indicated visually on the display of the electronic device. The stationary point is, for example, always at the center of the view window. The stationary point may also be visually indicated using, for example, an arrow, a circle, a target or a bead symbol.

In one embodiment of the invention the first point may be moved in the area of current view window. The first point is moved, for example, so that a pointer device used to scroll the hypertext page contents within the view window is set to a second mode where the view window may be frozen. During the second mode the first point may be moved.

In one embodiment of the invention, the link area is a separate structural element in the source code for the hypertext page.

In one embodiment of the invention, the electronic device is a mobile terminal and the hypertext page is larger than the display on the electronic device. In this embodiment, the view window is sized for the mobile terminal display. The view window may be relocated in relation to the hypertext page to display different parts of the hypertext page in its original size. The hypertext page is specified, for example, using HTML or XHTML languages or any other languages that are used to define pages to be browsed in computers with larger screens such as desktop computers or laptop computers.

In one embodiment of the invention, the view window is moved, that is, relocated in the area of the hypertext page using a pointer device.

In one embodiment of the invention, the electronic device is a SYMBIAN™ operating system device. In another embodiment of the invention, the electronic device is a Microsoft WINDOWS™ operating system device. The electronic device may be a General Packet Radio Service (GPRS) terminal or a Universal Mobile Telecommunications (UMTS) terminal.

In one embodiment of the invention the computer has a graphical user interface. The graphical user interface may be based on, for example, SYMBIAN™ operating system, Microsoft WINDOWS™ or other operating system.

In one embodiment of the invention, the computer program is stored on a computer readable medium. The computer readable medium may be a removable memory card, magnetic disk, optical disk or magnetic tape.

In one embodiment of the invention, the electronic device is a mobile device, for example, a laptop computer, palmtop computer, mobile terminal or a personal digital assistant (PDA). In one embodiment of the invention the electronic device is a desktop computer or any other computing device.

The benefits of the invention are related to the improved flexibility in operating a browser in an electronic device. The user interface is made increasingly user-friendly. The selection of links is possible quickly. There is no need to precisely guide a pointer device to the area of a specific single link description text, which would cause a stain on the eye. The avoiding of precision makes the link selection process possible also, for example, while the user is walking. The invention also avoids the need to collect and analyze browsing history in order to determine which links are more probable than other. This is due to the fact that it is no longer necessary to enlarge the snap areas associated with specific single link description texts.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a prior art method for facilitating user selection of links presented on a display;

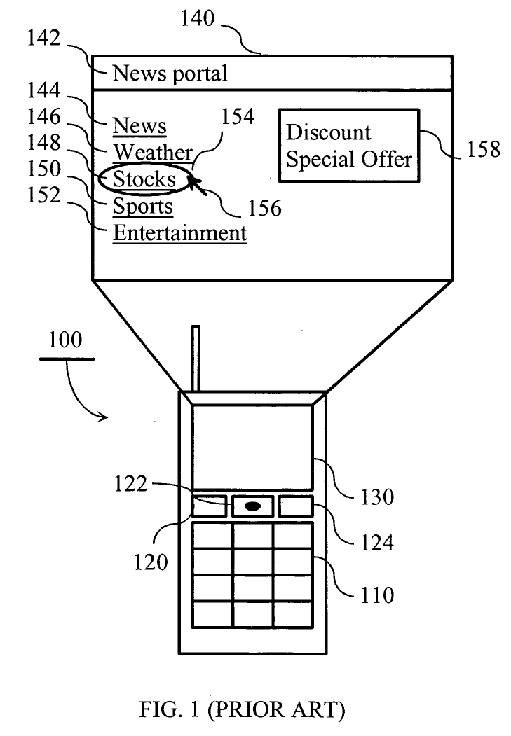

FIG. 2 depicts a hypertext page comprising a plurality of link groups arranged as table entries;

FIG. 3 is a block diagram illustrating the operation of an electronic device according to the invention;

FIG. 4 is a block diagram illustrating the structure of a hypertext document processed by an electronic device according to the invention;

FIG. 5 is a flow chart depicting one embodiment of a method for the presentation and selection of document links in small screen electronic devices; and

FIG. 6 is a block diagram illustrating the software and hardware architecture of an electronic device according to the invention.

### DETAILED DESCRIPTION OF THE EMBODIMENTS

Reference will now be made in detail to the embodiments of the present invention, examples of which are illustrated in the accompanying drawings.

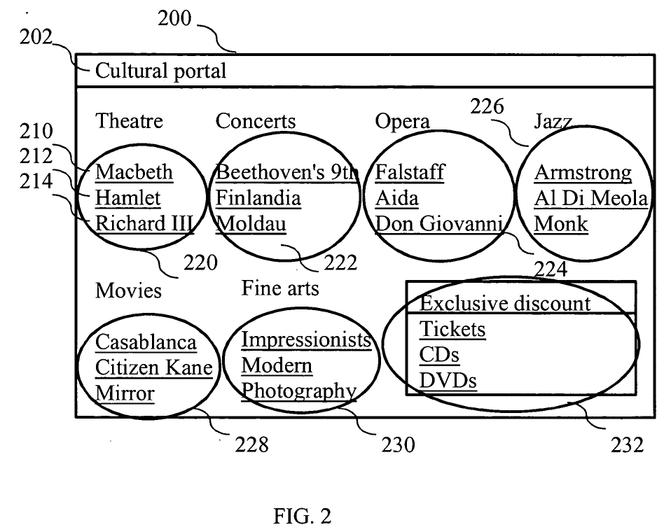

FIG. 2 depicts an exemplary hypertext page having a plurality groups that are arranged as table entries. Hypertext page 200 comprises a heading 202 and a plurality of link groups each in an area indicated with one of ovals 220-230. Hypertext page 200 represents a cultural information portal, which has different channels for different types of cultural events such as theatrical performances, concerts and operas. The channels comprise links to information collected from a variety of information sources. On hypertext page 200 there is one link group per each channel. Link groups in the area of ovals 220-230 are arranged as entries in a table comprising four columns and two rows. There is also an extra block 232 representing an advertisement frame. For example, link group for oval 220 comprises links 210-214, each link representing one play on theatres currently.

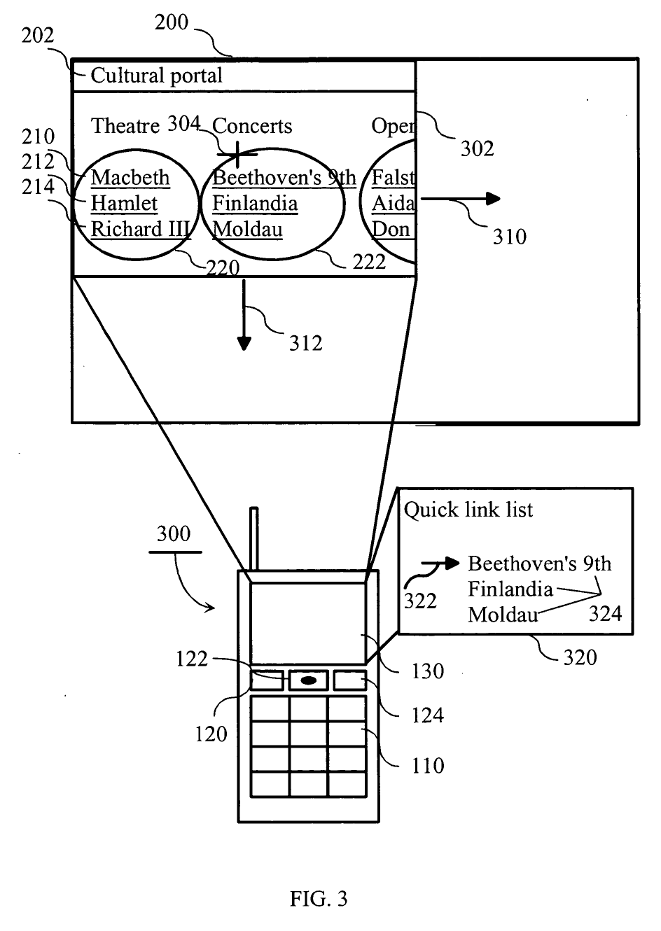

FIG. 3 is a block diagram illustrating the operation of an electronic device according to the invention when browsing hypertext page 200 from FIG. 2. Hypertext page 200 is first loaded to electronic device 300, which is, for example, a GPRS or UMTS mobile terminal. Hypertext page 200 is loaded in the memory of electronic device 300 using, for example, the Hypertext Transfer Protocol (HTTP), defined in Internet Engineering Task Force document RFC 2068. Hypertext page 200 may be loaded also using other protocols for the transfer of documents such as the WAP protocols or the File Transfer Protocol (FTP). Hypertext page 200 is parsed by electronic device 300. A view window 302 comprising a part of hypertext page 200 is rendered for presentation in a display 130 associated with electronic device 300. View window 302 may be relocated on hypertext page 200 so that view window 302 may be moved to a position, which comprises a part of hypertext page 200 desired for viewing. In other words, view window 302 is sized for a small display. View window 302 may be relocated in relation to hypertext page 200 to display different parts of hypertext page 200. In one embodiment of the invention, the hypertext page 200 maintains its layout as intended for larger screen devices in background, but view window 302 provides a peek window to view a limited piece of hypertext page 200 at a given time. However, it should be noted that entire hypertext page 200 does not necessarily exist in the final graphical format in the device memory area. Instead, the entire hypertext page 200 exists merely as a model, which is used to form the current contents of view window 302 when it is moved to a new place within the boundaries of hypertext page 200.

In one embodiment of the invention, view window 302 may be moved vertically and horizontally within the area of hypertext page 200. The vertical and horizontal scrolling of view window 302 is determined with a pointer device 122. In one embodiment of the invention, view window 302 is scrolled in steps smaller than the size of view window 302, for example, in steps of a certain number of pixels. In one embodiment of the invention view window 302 may be scrolled in steps of two sizes, namely, in step equal to the size of window 302 and in steps smaller than view window 302. For example, there may be separate keys for the scrolling of view window 302 in window sized steps. In FIG. 3 arrows 310 and 312 represent horizontal and vertical scrolling directions for view window 302. Box 200 represents the boundaries of hypertext page 200 and thus the scrolling boundaries for view window 302 inside hypertext page 200.

In FIG. 3 there are two oval shaped link areas, namely ovals 220 and 222, each of which designate a separate link group. Oval 220 designates a link group relating to theatre information that comprises links 210214. Oval 222 designates a link group relating to concerts. The center of the screen 130 in electronic device 300 is indicated with two lines crossing at pivot point 304. The user may be presented a target symbol or a bead, which indicates the precise location of pivot point 304. The proximity of each link area to pivot point 304 is computed by electronic device 300 always when user scrolls view window 302 in order to position it to a different place on hypertext page 200. The link area closest to pivot point 304 is selected by electronic device 300.

In one embodiment of the invention the link area closest to pivot point 304 is the one that has a point closest to pivot point 304. It should be noted that pivot point 304 may actually be located inside a given link area. In one embodiment of the invention, the link area closest to pivot point 304 is the one with the center of gravity closest to pivot point 304. In FIG. 3 the link area closest to pivot point 304 is the link area represented by oval 222. The link area closest to pivot point 304 is used to form a quick link list, such as list 324. The user may open a quick link list in a separate window 320. When quick link list window 320 is open, the user may move a cursor 322 using pointer device 122 to point to a specific link. As the user issues a selection event, for example, presses the pointer device inwards, the link pointed to by cursor 322 is selected. Thereafter, the document pointed to by the selected link may be downloaded to electronic device 300 and rendered to display 130 in a manner similar to hypertext document 200.

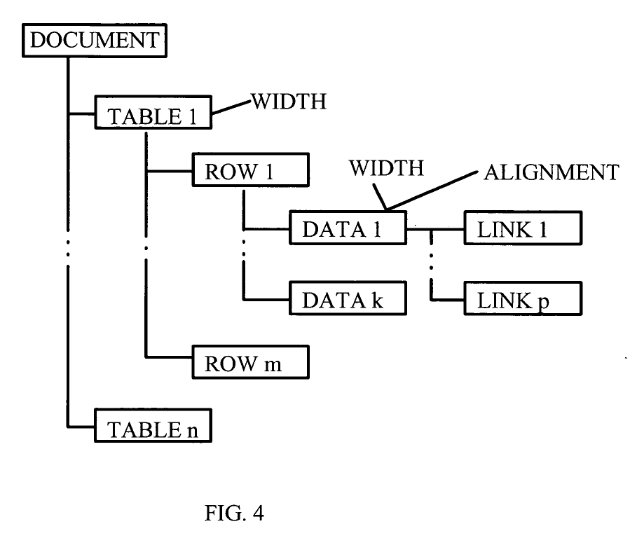

FIG. 4 is a block diagram illustrating the structure of a hypertext document processed by an electronic device according to the invention. The document is composed of a number of structural elements. In one embodiment of the invention a hypertext document comprises at least one table. The tables comprise at least one row. On each row there are a number of table entries, which correspond to table columns on a row. In each table entry there may be one or many links. Each link comprises at least a visual description of the link and a reference to a second hypertext document. The reference may be, for example, an Internet Uniform Resource Locator (URL). Associated with a table there may be a width attribute, which specifies the width of the table, for example, in pixels. Similarly, associated with a table entry there may be also a width attribute. There is also an alignment attribute, which specifies whether the text presented in the table entry should be aligned left side, right side or the center of the table entry.

A hypertext document may be specified using, for example, Hypertext Markup Language (HTML), Wireless Markup Language (WML) or XML (Extensible Markup Language). In a markup language such as HTML there are tags that indicate the categories for the different elements in a document. There are element start and end tags. For example, in HTML a table element is specified with the tag “TABLE”, a table row with the tag “TR” and a table entry with a tag “TD”. The document may be stored and transported in, for example, character or binary format.

In one embodiment of the invention, the document may be specified using an object oriented notation where the document elements are seen as instances of a given element class. The classes may be defined in a separate schema document. In one embodiment of the invention a link area is not specified using table, row and table entry entity notions, but instead, there is defined an area entity for containing a number of links. An area entity may have, for example, a rectangular shape. The shape may also be irregular. An area entity has as its attributes the absolute or relative coordinates for placing the area onto the hypertext page rendered for output and the area boundaries. In the case of a rectangular area, the area boundaries are the length and the width of the area. Similarly, there may be other mechanisms for determining the location of a link area on a hypertext page. For example, the browser may provide automatic mechanisms for arranging the link areas onto the browser output window.

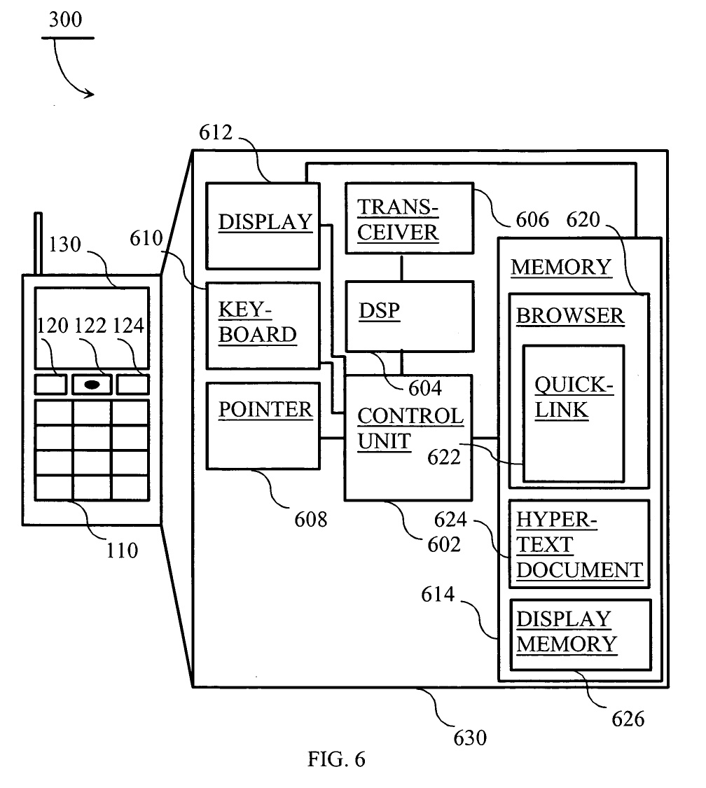

FIG. 6 is a block diagram illustrating the software and hardware architecture of an electronic device according to the invention. Electronic device 300 has a keyboard 110, function keys 120 and 124, pointer device 122 and display 130. Keyboard 110 may be, for example, a mobile terminal keypad or a larger keyboard, which has separate keys for typing letters such as a standard computer keyboard. Display 130 may be, for example, a Liquid Crystal Display (LCD). The display may also be significantly larger than displays in normal mobile terminals. The box 630 represents the internal components of electronic device 300. Electronic device 300 has a control unit 602, display controller circuit 612, keyboard controller circuit 610, a pointer device controller circuit 608, a radio transceiver 606 and a DSP unit 604. The control unit 602 is connected to a central memory 614, which comprises a display memory area 626. The display memory area 626 is read also from display controller circuit 612. In central memory is stored a browser application 620 at least when it is executed. Browser application 620 comprises link management means 622. To central memory 614 may be stored at least one hypertext document 624.

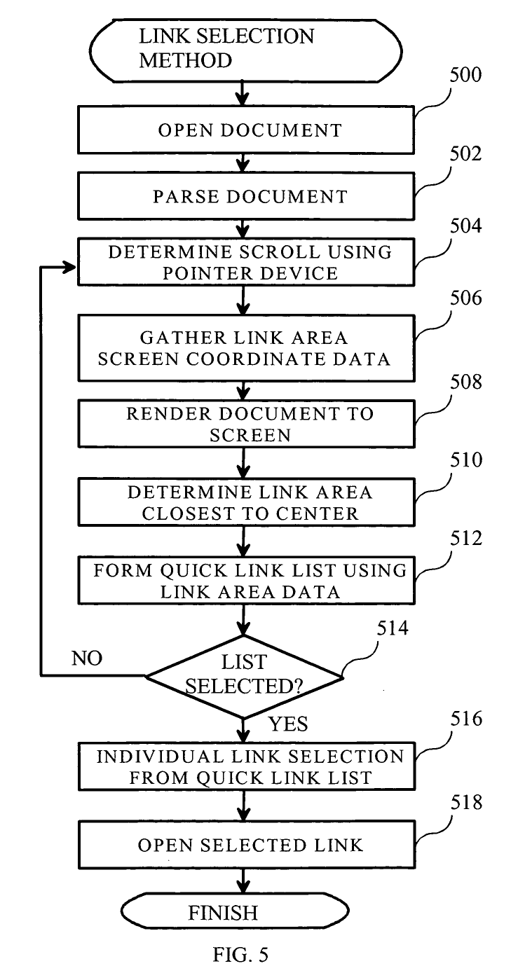

FIG. 5 is a flow chart depicting one embodiment of a method for the presentation and selection of document links in small screen electronic devices such as electronic device 300 in FIG. 3.

At step 500 electronic device 300 retrieves a hypertext document, which is used to form hypertext page 200 rendered for presentation. In one embodiment of the invention the hypertext document is structured as presented in FIG. 4. The hypertext document is obtained in response to, for example, an HTTP GET operation sent to a network server. The hypertext document is stored into central memory 614.

At step 502 the obtained hypertext document is parsed. In one embodiment of the invention, a character format document goes through lexical analysis to extract the structural elements from the raw document. The structural elements in the hypertext document are used to form an internal model, that is, an internal representation of the hypertext document. The internal model may be, for example, an object model. The object model contains each structural element from the hypertext document. Each structural element becomes an instance of an object class, which corresponds to the element type. The object model may be, for example, in compliance with the World Wide Web Consortium (W3C) Domain Object Model (DOM). In one embodiment of the invention the table and the table entry instances comprise parameters to store the width attribute. The table instances comprise parameters for style and font attributes. These parameters are used together with link instances to determine the size for each table entry. From the table entry size may be determined the link area size pertaining to the table entry.

At step 504 the position for view window 302 inside hypertext page 200 is determined. The position coordinates are determined based on scrolling commands issued by the user with pointer device 122 or any function key. Initially, as a new hypertext page is opened for viewing, view window 302 is placed, for example, to the upper left corner of hypertext page 200. When a new position for view window 302 is determined in hypertext page 200, the boundary coordinates for the hypertext page 200 area becoming visible in view window 302 are computed. Based on the boundary coordinates it can be determined what visual structural element comprise data to be presented in view window 302.

At step 506 the internal model of the hypertext document is analyzed to determine the placing and positions for the visual structural elements that contribute to the visual representation of the hypertext page, for example, tables and link descriptions contained in table entries. Other visual structural elements comprise, for example, text paragraphs, headers and embedded images. Further, at step 506 the link area positions and sizes are defined for each link area visible within the current view window 302. For example, for a table entry is defined the location and the size of the link area pertaining to that entry. The size of a given link area is dependent on a variety of factors including the number of links contained in it, link description text fonts, font sizes and text string lengths. The end result is that coordinate ranges pertaining to the link areas are determined.

At step 508 the visual structural elements within the area of view window 302 are formed into display memory area 626 within electronic device 300. Thereupon, display controller circuit 612 controls electronic device display 130 based on information in the display memory. The result is that the fragment in hypertext page 200 currently in the area of view window 302 becomes visible in electronic device display 130.

At step 510 is determined the link area, which is closest to pivot point 304. At step 512 the closest link area is used to form a quick link list. This means that the links in the closest link area are extracted and stored to a separate list structure, which is stored in electronic device 300 memory. In one embodiment of the hypertext pages pointed to by the links in the quick link list are retrieved automatically to electronic device 300 as a background activity in behalf of the user.

At step 514 is determined whether the user has pressed a key or performed any other user interface action, which results in the presentation of the quick link list. In one embodiment of the invention the key used for quick link list presentation is a programmable key, for example, one of function keys 120 and 122. If the user has not decided to open the quick link list, pointer device 122 related events are checked by electronic device 300 and the method continues at step 506. By pointer device related events are meant herein such events as the moving of a pointer device and the pressing of the pointer device inwards. In one embodiment of the invention, pointer device events are detected using pointer device control circuit 608.

At step 516 the quick link list is presented in a separate window or view within the electronic device display. In FIG. 3 a window 320 is such a separate window or view. Window 320 comprises cursor 322, which may be moved by the user using pointer device 122 or keys in the electronic device keypad. Using the cursor 322, the user selects the desired link. As the user issues a selection event, for example, presses the pointer device inwards, the link pointed to by cursor 322 is selected. In one embodiment of the invention, the links in the quick link list are embedded to the terminal option field. The terminal option field is opened, for example, using a function key, which has above it the description text “Options”. This is, for example, function key 122 in electronic device 300. At step 518 the document pointed to by the selected link is downloaded to electronic device 300 and rendered to display 130 in a manner similar to hypertext document 200.

It is obvious to a person skilled in the art that with the advancement of technology, the basic idea of the invention may be implemented in various ways. The invention and its embodiments are thus not limited to the examples described above; instead they may vary within the scope of the claims.

1. A method for document link presentation and selection in an electronic device, the method comprising:
opening a first hypertext page comprising at least one separate link area in said electronic device;
displaying at least part of said first hypertext page in a view window movable in the area of said first hypertext page;
determining a link area nearest to a first point on said view window;
forming a link list comprising links associated with said link area;
allowing a user to select a first link in said link list; and
opening a second hypertext page indicated by said first link in said electronic device.

2. The method according to claim 1, the method further comprising:
activating said link list in response to a user interface event; and presenting said link list in a separate window.

3. The method according to claim 1, the method further comprising:
determining a logical order for at least two links in said link list based on a spatial order of the link descriptions on said first hypertext page;
assigning at least two keys in said electronic device for said at least two links based on said logical order; and
communicating said selection of said first link by pressing one of said at least two keys.

4. The method according to claim 3, wherein said at least two keys are function keys.

5. The method according to claim 3, wherein said at least two keys are number keys.

6. The method according to claim 1, wherein said first point is a stationary point on said view window and the link area nearest to said stationary point is indicated visually on the display of said electronic device.

7. The method according to claim 6, wherein said stationary point is at the center of said view window.

8. The method according to claim 1, wherein said link area is a separate structural element in the source code for said hypertext page.

9. The method according to claim 1, wherein said electronic device is a mobile terminal and said hypertext page is larger than the display on said electronic device.

10. The method according to claim 9, wherein said hypertext page is specified using HTML or XHTML.

11. The method according to claim 1, wherein said view window is moved in the area of said hypertext page using a pointer device.

12. The method according to claim 1, wherein said electronic device is a SYMBIAN™ operating system device.

13. The method according to claim 1, wherein said electronic device is a Microsoft WINDOWS™ operating system device.

14. The method according to claim 1, wherein said electronic device is a GPRS terminal or a UMTS terminal.

15. An electronic device for document link presentation and selection comprising:
a memory to store at least a browser application;
a display to show a view window;
a pointer device;
a processor coupled to the memory, the display and the pointer device, wherein the processor is arranged
to open a first hypertext page comprising at least one separate link area,
to display at least part of said first hypertext page in said view window,
to move said view window in the area of said first hypertext page in response to operation of said pointer device,
to determine a link area nearest to a first point on said view window,
to form a link list comprising links associated with said link area,
to allow a user to select a first link in said link list, and
to open a second hypertext page indicated by said first link.

16. The electronic device according to claim 15, wherein the processor is further arranged to activate said link list in response to a user interface event and said display is further arranged to show said link list in a separate window.

17. The electronic device according to claim 15, wherein the processor is further arranged to determine a logical order for at least two links in said link list based on a spatial order of the link descriptions on said first hypertext page, to assign at least two keys in said electronic device for said at least two links based on said logical order and to detect said selection of said first link from the pressing one of said at least two keys.

18. The electronic device according to claim 17, wherein said at least two keys are function keys.

19. The electronic device according to claim 17, wherein said at least two keys are number keys.

20. The electronic device according to claim 15, wherein said first point is a stationary point on said view window and said display is further arranged to indicate the link area nearest to said stationary point.

21. The electronic device according to claim 20, wherein said stationary point is at the center of said view window.

22. The electronic device according to claim 15, wherein said link area is a separate structural element in the source code for said hypertext page.

23. The electronic device according to claim 15, wherein said electronic device is a mobile terminal and said hypertext page is larger than the display on said electronic device.

24. The electronic device according to claim 23, wherein said hypertext page is specified using HTML or XHTML.

25. The electronic device according to claim 15, wherein said view window is moved in the area of said hypertext page using a joystick.

26. The electronic device according to claim 15, wherein said electronic device is a SYMBIAN™ operating system device.

27. The electronic device according to claim 15, wherein said electronic device is a Microsoft WINDOWS™ operating system device.

28. The electronic device according to claim 15, wherein said electronic device is a GPRS terminal or a UMTS terminal.

29. A computer program comprising code adapted to perform the following steps when executed on a data-processing system:
opening a first hypertext page comprising at least one separate link area in an electronic device;
displaying in the display of said electronic device at least part of said first hypertext page in a view window movable in the area of said first hypertext page;
determining in said electronic device a link area nearest to a first point on said view window;
forming in said electronic device a link list comprising links associated with said link area;
allowing a user to select a first link in said link list; and
opening in said electronic device a second hypertext page indicated by said first link.

30. The computer program according to claim 29, further adapted to perform the following steps when executed on said data-processing system:
activating said link list in response to a user interface event; and presenting said link list in a separate window.

31. The computer program according to claim 29, further adapted to perform the following steps when executed on said data-processing system:
determining a logical order for at least two links in said link list based on a spatial order of the link descriptions on said first hypertext page;
assigning at least two keys in said electronic device for said at least two links based on said logical order; and
communicating said selection of said first link by pressing one of said at least two keys.

32. The computer program according to claim 31, wherein said at least two keys are function keys.

33. The computer program according to claim 31, wherein said at least two keys are number keys.

34. The computer program according to claim 29, wherein said first point is a stationary point on said view window and the link area nearest to said stationary point is indicated visually on the display of said electronic device.

35. The computer program according to claim 34, wherein said stationary point is at the center of said view window.

36. The computer program according to claim 29, wherein said link area is a separate structural element in the source code for said hypertext page.

37. The computer program according to claim 29, wherein said electronic device is a mobile terminal and said hypertext page is larger than the display on said electronic device.

38. The computer program according to claim 37, wherein said hypertext page is specified using HTML or XHTML.

39. The computer program according to claim 29, wherein said view window is moved in the area of said hypertext page using a pointer device.

40. The computer program according to claim 29, wherein said electronic device is a SYMBIAN™ operating system device.

41. The computer program according to claim 29, wherein said electronic device is a Microsoft WINDOWS™ operating system device.

42. The computer program according to claim 29, wherein said electronic device is a GPRS terminal or a UMTS terminal.

43. The computer program according to claim 29, wherein said computer program is stored on a computer readable medium.

44. The computer program according to claim 43, wherein said computer readable medium is a removable memory card.

45. The computer program according to claim 43, wherein said computer readable medium is a magnetic or an optical disk.
